(19) United States
(12) Patent Application Publication
(10) Pub. No.: US 2026/0358308 A1
(43) Pub. Date: Nov. 12, 2026

(54) CHROMATOGRAM ANALYSIS APPARATUS AND CHROMATOGRAM ANALYSIS METHOD

(71) Applicant: SHIMADZU CORPORATION, Kyoto-shi (JP)

(72) Inventor: Harunori KAWAI, Kyoto-shi (JP)

(21) Appl. No.: 19/656,618

(22) Filed: Apr. 23, 2026

(30) Foreign Application Priority Data
May 9, 2025 (JP) 2025-078471

(51) Int. Cl. G01N 30/86

(52) U.S. Cl. CPC G01N 30/8675; G01N 30/8624

(57) ABSTRACT

A chromatogram analysis apparatus includes: an analysis target chromatogram holder that holds a plurality of analysis target chromatograms obtained by analyzing a plurality of samples containing a specific component at different concentrations under the same analysis conditions; a chromatogram synthesizer configured to create a synthesized chromatogram by synthesizing the plurality of analysis target chromatograms held by the analysis target chromatogram holder with each other in a predetermined range including at least a retention time range of the specific component; a waveform processor configured to execute waveform processing on the synthesized chromatogram created by the chromatogram synthesizer and obtain waveform processing information for defining respective regions of all peaks of the synthesized chromatogram; and a chromatogram processor configured to define a region of a peak of the specific component of each of the plurality of analysis target chromatograms by applying the waveform processing information obtained by the waveform processor to each of the plurality of analysis target chromatograms.

### TECHNICAL FIELD

The present invention relates to a chromatogram analysis apparatus and a chromatogram analysis method for analyzing a plurality of chromatograms obtained by chromatographic analysis.

### BACKGROUND ART

There are cases where respective chromatograms of a plurality of samples having different composition balances (concentration ratios between contained components) are obtained, and some evaluation is performed based on those chromatograms. For example, in order to investigate the reaction time required for the synthesis of a chemical, chromatograms may be obtained periodically during the synthesis process to track the peak areas of the target product and reactants, thereby evaluating the progress of the synthesis reaction. Further, there are cases where the uniformity between lots of manufactured chemicals or the like is evaluated, or lot abnormalities are detected.

### SUMMARY OF INVENTION

### Technical Problem

In order to evaluate the chromatograms of a plurality of samples having different composition balances as described above, the region of a peak appearing in each chromatogram is defined. Here, when the appearance positions (retention times) of the peaks of a plurality of components are close to each other, causing the plurality of peaks to partially overlap and be continuous, it is necessary to perform waveform processing to separate the continuous plurality of peaks from each other so that the area of each peak corresponds to the concentration of the respective component. However, when a large number of chromatograms exist, it takes a long time to perform waveform processing for each chromatogram. Further, since the content of the same component corresponding to each chromatogram differs, and the peak area and peak shape differ, it is not easy to apply consistent waveform processing to all chromatograms even if the same waveform processing algorithm is used. If the waveform processing differs for each chromatogram, the calculation process of the peak area will differ, so that, for example, an accurate calibration curve cannot be created, and the content cannot be properly specified.

The present invention has been made in view of the above problems, and an object thereof is to enable rapid and easy execution of analysis of chromatograms of a plurality of samples having different composition balances.

### Solution to Problem

A chromatogram analysis apparatus according to the present invention includes:
an analysis target chromatogram holder that holds a plurality of analysis target chromatograms in which appearance positions of peaks of the same component coincide with each other;
   a chromatogram synthesizer configured to synthesize the plurality of analysis target chromatograms held by the analysis target chromatogram holder with each other in a predetermined range to create a synthesized chromatogram in which all peaks of components appearing in the plurality of analysis target chromatograms in the predetermined range appear;
   a waveform processor configured to execute waveform processing on the synthesized chromatogram created by the chromatogram synthesizer to obtain waveform processing information for defining respective regions of all appearing peaks of the synthesized chromatogram; and
   a chromatogram processor configured to define a region of an appearing peak within the predetermined range of each of the plurality of analysis target chromatograms by applying the waveform processing information obtained by the waveform processor to all of the plurality of analysis target chromatograms.

A chromatogram analysis method according to the present invention includes:
a preparation step of preparing a plurality of analysis target chromatograms in which appearance positions of peaks of the same component coincide with each other;
a synthesis step of creating a synthesized chromatogram in which all peaks of components appearing in the plurality of analysis target chromatograms in a predetermined range appear, by synthesizing the plurality of analysis target chromatograms prepared in the preparation step with each other in the predetermined range;
   a waveform processing step of obtaining waveform processing information for defining respective regions of all appearing peaks of the synthesized chromatogram by executing waveform processing on the synthesized chromatogram created in the synthesis step;
   a chromatogram processing step of defining a region of an appearing peak within the predetermined range of each of the plurality of analysis target chromatograms by applying the waveform processing information obtained in the waveform processing step to all of the plurality of analysis target chromatograms; and
   a chromatogram evaluation step of evaluating the plurality of analysis target chromatograms based on the region of the appearing peak of each of the plurality of analysis target chromatograms defined in the chromatogram processing step.

### Advantageous Effects of Invention

According to the chromatogram analysis apparatus of the present invention, a synthesized chromatogram is created in which all of the peaks appearing in the predetermined range in each of the plurality of analysis target chromatograms appear, waveform processing is performed on the synthesized chromatogram to obtain waveform processing information for defining the regions of all appearing peaks of the synthesized chromatogram, and then the acquired waveform processing information is applied to each analysis target chromatogram to define the region of the appearing peak within the predetermined range of each analysis target chromatogram. Therefore, waveform processing of a plurality of analysis target chromatograms can be executed rapidly, easily, and with consistency. Thereby, analysis of chromatograms of a plurality of samples having different composition balances can be executed rapidly and easily. Further, since the content of a specific component differs for each analysis target chromatogram, the shape of the peak of the specific component differs for each chromatogram; however, by using the synthesized chromatogram, waveform processing can be performed taking into account the features of the peaks of each chromatogram.

According to the chromatogram analysis method of the present invention, a synthesized chromatogram is created in which all of the peaks appearing in the predetermined range in each of the plurality of analysis target chromatograms appear, waveform processing is performed on the synthesized chromatogram to obtain waveform processing information for defining the regions of all appearing peaks of the synthesized chromatogram, and then the acquired waveform processing information is applied to each analysis target chromatogram to define the region of the appearing peak within the predetermined range of each analysis target chromatogram, and the plurality of analysis target chromatograms are evaluated based on the result. Therefore, waveform processing of a plurality of analysis target chromatograms can be executed rapidly, easily, and with consistency. Thereby, evaluation using chromatograms of a plurality of samples having different composition balances can be executed rapidly and easily. Further, since the content of a specific component differs for each analysis target chromatogram, the shape of the peak of the specific component differs for each chromatogram; however, by using the synthesized chromatogram, waveform processing can be performed taking into account the features of the peaks of each chromatogram.

### BRIEF DESCRIPTION OF DRAWINGS

FIG. 1 is a block diagram showing an embodiment of a chromatogram analysis apparatus.

FIG. 2 is a flowchart showing an embodiment of a chromatogram analysis method.

FIG. 3 is a diagram showing an example of a plurality of analysis target chromatograms.

FIG. 4 is a conceptual diagram for explaining an example of synthesis of chromatograms.

FIG. 5 is a conceptual diagram for explaining an example of waveform processing of each analysis target chromatogram.

### DESCRIPTION OF EMBODIMENTS

Hereinafter, an embodiment of a chromatogram analysis apparatus and a chromatogram analysis method will be described with reference to the drawings.

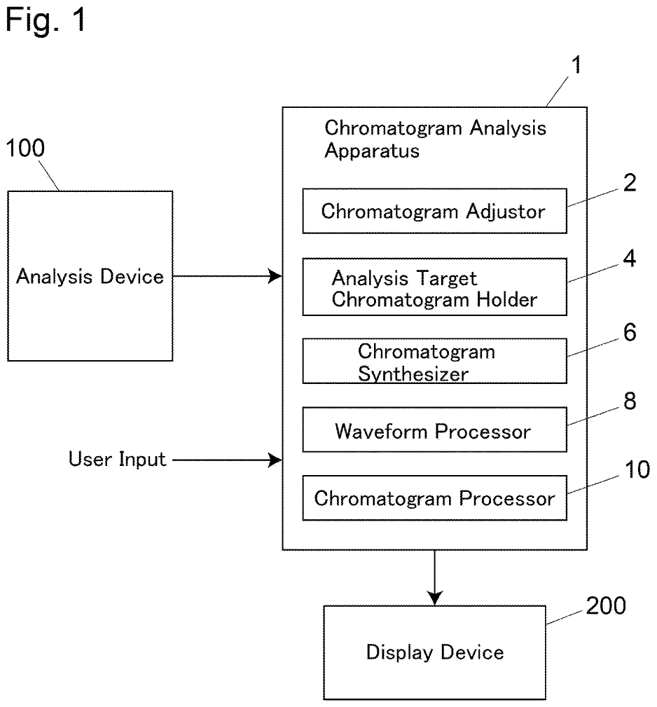

As shown in FIG. 1, the chromatogram analysis apparatus 1 includes a chromatogram adjustor 2, an analysis target chromatogram holder 4, a chromatogram synthesizer 6, a waveform processor 8, and a chromatogram processor 10. This chromatogram analysis apparatus 1 has a function of simultaneously processing and analyzing a plurality of chromatograms. The plurality of chromatograms processed simultaneously by the chromatogram analysis apparatus 1 are obtained by chromatographically analyzing a plurality of samples containing the same components but having mutually different composition balances under the same analysis conditions.

The chromatogram analysis apparatus 1 is a computer device (for example, a personal computer) into which a program is introduced for taking in a plurality of chromatograms obtained by an analysis device 100 such as an LC or GC and executing various processes necessary for analyzing the taken-in plurality of chromatograms. The chromatogram analysis apparatus 1 includes a reception unit (not shown) for receiving user input, and is communicably connected to a display device 200 that performs information display. The chromatogram analysis apparatus 1 executes processing necessary for chromatogram analysis based on user input, and displays the processing result on the display device 200.

Each of the chromatogram adjustor 2, the chromatogram synthesizer 6, the waveform processor 8, and the chromatogram processor 10 is a function obtained by executing a corresponding program in the computer device constituting the chromatogram analysis apparatus 1, and the analysis target chromatogram holder 4 is a function realized by a storage area of a part of an information storage device mounted on the computer device constituting the chromatogram analysis apparatus 1.

The chromatogram adjustor 2 is configured to execute alignment of a plurality of chromatograms obtained for a plurality of samples having different composition balances (that is, containing the same specific components at different concentrations). Alignment is a process of adjusting at least some chromatograms among the plurality of chromatograms in the retention time (horizontal axis) direction so that the appearance positions (retention times) of mutually corresponding peaks (peaks of the same component) coincide with each other. Examples of algorithms used for alignment include Dynamic Time Warping (DTW) and the like. Note that the appearance positions (times) of the peaks of the same component coinciding with each other is not limited to the positions of the peak tops of the same component completely matching, but also includes cases where the positions of the peak tops of the same component fall within a predetermined range from a reference position (for example, the position of a peak top of a reference chromatogram).

The analysis target chromatogram holder 4 is configured to hold the plurality of chromatograms subjected to alignment by the chromatogram adjustor 2 as analysis target chromatograms.

The chromatogram synthesizer 6 is configured to synthesize the plurality of analysis target chromatograms held in the analysis target chromatogram holder 4 to create a synthesized chromatogram in which all of the peaks appearing in each of the analysis target chromatograms appear in one chromatogram. The synthesis of the plurality of analysis target chromatograms may be performed by summing the signal intensities of each of the plurality of analysis target chromatograms, or may be performed by adopting the maximum signal intensity among the signal intensities of the plurality of analysis target chromatograms as the signal intensity at each time point on the retention time axis. Note that the range (range of retention time) for synthesizing the analysis target chromatograms may be arbitrarily designatable by the user. If the user can arbitrarily designate the range to be synthesized, the waveform processing of the synthesized chromatogram and the waveform processing of each analysis target chromatogram described below can also be executed in the range designated by the user.

The waveform processor 8 is configured to perform waveform processing of the synthesized chromatogram created by the chromatogram synthesizer 6 and store parameters and settings used at that time. Waveform processing is processing for obtaining waveform processing information for defining regions of all peaks appearing on the synthesized chromatogram. The waveform processing information is information regarding a baseline, information regarding a start point and an end point of each peak of the synthesized chromatogram, and information indicating how to separate unresolved peaks in which peaks of a plurality of components overlap. The waveform processor 8 may be configured to automatically execute waveform processing using an existing algorithm, or may be configured to execute user-manual waveform processing in which the user inputs a separation line for separating unresolved peaks. The waveform processor 8 specifies and stores waveform processing information including information regarding the separation line for separation set in such a manner. Examples of the waveform processing information for separating unresolved peaks include parameters such as the retention time of the start point and the retention time of the end point of a separation line for separating unresolved peaks, or the retention time of the start point and the angle of the separation line, and settings such as whether to consider peak tailing.

The chromatogram processor 10 is configured to apply the waveform processing information obtained by the waveform processing of the synthesized chromatogram to all analysis target chromatograms collectively, and define the regions of all appearing peaks of each analysis target chromatogram. In an example of a method for applying the waveform processing information to all analysis target chromatograms, the retention time of the start point and the retention time of the end point of the separation line drawn to separate the unresolved peaks in the waveform processing of the synthesized chromatogram are used as the retention time of the start point and the retention time of the end point of a straight line drawn to separate overlapping peaks in each analysis target chromatogram. More specifically, a straight line is drawn from the intensity point at the retention time of the start point to the intensity point at the retention time of the end point in the analysis target chromatogram. Further, as another method, the retention time of the start point and the slope of the separation line of the synthesized chromatogram are obtained, and a separation line with the slope is drawn from the intensity point at the retention time of the start point in the analysis target chromatogram. Further, when a setting to consider peak tailing is made, the separation line is further inclined by a predetermined value.

The chromatogram analysis apparatus 1 may include a function of calculating the area of the region of the appearing peak of each analysis target chromatogram defined by the chromatogram processor 10. The user can evaluate all analysis target chromatograms by, for example, comparing peak areas of specific components of each analysis target chromatogram.

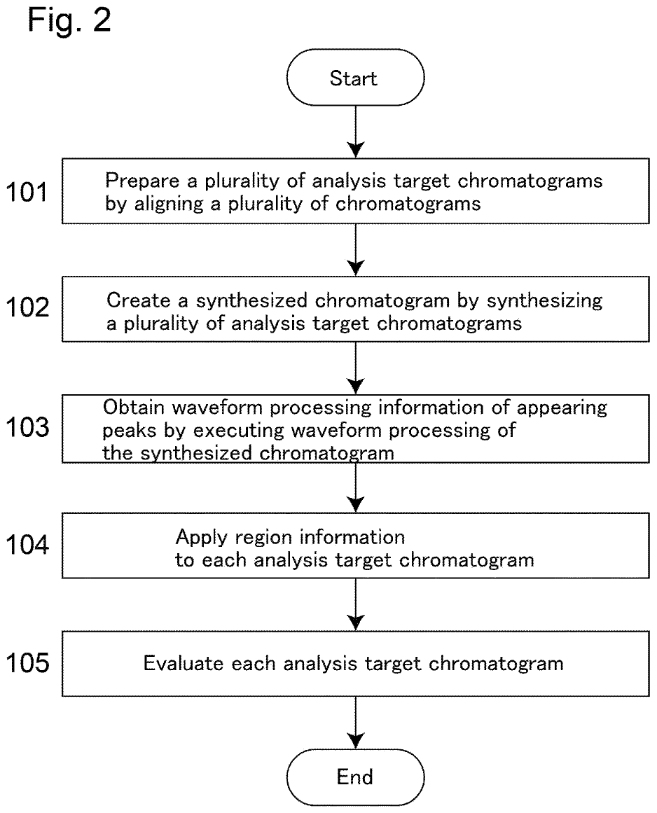

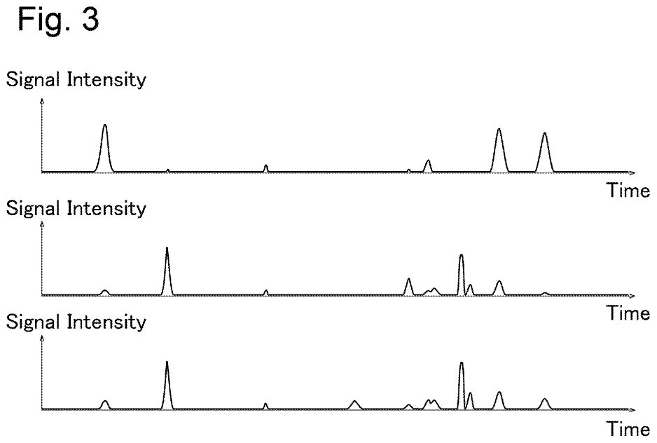

A chromatogram analysis method using each of the above functions will be described with reference to the flowchart of FIG. 2 as well as FIGS. 3, 4, and 5.

As a premise, it is assumed that there are a plurality of chromatograms obtained by chromatographically analyzing a plurality of samples containing the same components but having mutually different composition balances under the same analysis conditions. By performing alignment of the plurality of chromatograms using the function of the chromatogram adjustor 2, a plurality of analysis target chromatograms in which the appearance positions of peaks of the same component coincide with each other as shown in FIG. 3 are prepared (Step 101). Note that if the appearance positions of peaks of the same component already coincide among the plurality of chromatograms, it is not always necessary to execute alignment, and the plurality of chromatograms can be used as the plurality of analysis target chromatograms as they are.

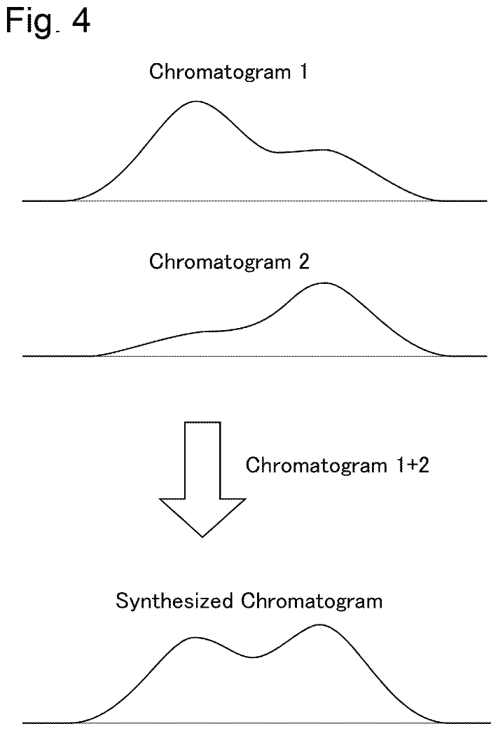

Next, using the function of the chromatogram synthesizer 6, as shown in FIG. 4, a synthesized chromatogram is created by synthesizing the plurality of analysis target chromatograms within a predetermined range (Step 102). FIG. 4 shows an example in which two chromatograms (Chromatogram 1 and Chromatogram 2) are synthesized by summing their respective signal intensities. Note that the range for synthesizing the analysis target chromatograms may be an arbitrary range or a predetermined range (for example, the entire range). FIG. 4 shows only a portion where peaks of two specific components overlap in Chromatograms 1 and 2.

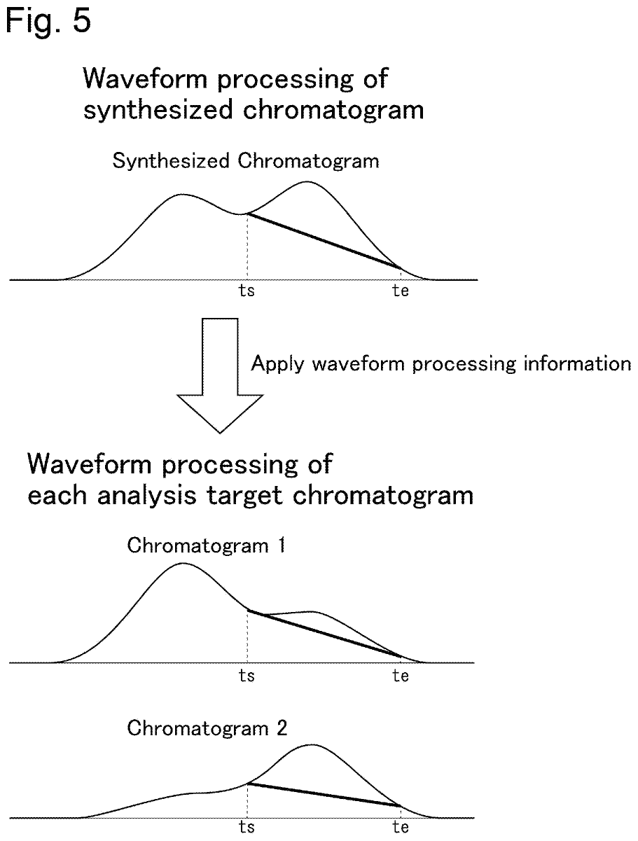

After creating the synthesized chromatogram, as shown in the upper diagram of FIG. 5, waveform processing is executed on the created synthesized chromatogram to obtain waveform processing information for defining regions of all peaks appearing in the synthesized chromatogram (Step 103). In the upper diagram of FIG. 5, an unresolved peak where two peaks overlap is divided by one separation line to define the region of each peak. In this waveform processing, a retention time ts of the start point and a retention time te of the end point of the separation line drawn to define the peaks of the two components are obtained as the waveform processing information for separating the unresolved peak.

After performing the waveform processing of the synthesized chromatogram and obtaining the waveform processing information, the waveform processing information is applied to each analysis target chromatogram as shown in the lower diagram of FIG. 5 (Step 104). Thereby, the region of each peak appearing in each of the analysis target chromatograms can be defined. In the example of the lower diagram of FIG. 5, in order to define the respective regions of two peaks partially overlapping each other, a separation line having the retention time ts as the start point and the retention time te as the end point is drawn.

Although FIGS. 4 and 5 use two analysis target chromatograms 1 and 2 for explanation in order to make the concept of synthesis and waveform processing of analysis target chromatograms easy to understand, the concept of the present invention of applying waveform processing information obtained by waveform processing on a synthesized chromatogram to each analysis target chromatogram is effective in that, when a large number of analysis target chromatograms exist, the time required for waveform processing can be significantly reduced compared to the case where waveform processing is individually performed for each analysis target chromatogram.

However, since the peak width differs depending on the size of the peak, if the same waveform processing information (information regarding the start point and end point of each peak) obtained by the waveform processing of the synthesized chromatogram is applied to each analysis target chromatogram as described above, it is assumed that the respective regions of the plurality of overlapping peaks may not be accurately defined. Therefore, although not shown in FIG. 2, after executing waveform processing by applying the waveform processing information to each analysis target chromatogram, the user may be able to manually correct the result of waveform processing in an arbitrary analysis target chromatogram as necessary.

After performing the waveform processing of each analysis target chromatogram by applying the waveform processing information as described above, each analysis target chromatogram is evaluated by calculating the area of each peak whose region has been defined by the waveform processing in each analysis target chromatogram, and comparing the peak areas of the same component among the plurality of analysis target chromatograms (Step 105).

The embodiment described above is merely an example of an embodiment of the chromatogram analysis apparatus and the chromatogram analysis method according to the present invention. Embodiments of the chromatogram analysis apparatus and the chromatogram analysis method according to the present invention are as follows.

In an embodiment of the chromatogram analysis apparatus according to the present invention, the apparatus includes: an analysis target chromatogram holder that holds a plurality of analysis target chromatograms obtained by analyzing a plurality of samples containing a specific component at different concentrations under the same analysis conditions; a chromatogram synthesizer configured to create a synthesized chromatogram by synthesizing the plurality of analysis target chromatograms held by the analysis target chromatogram holder with each other in a predetermined range including at least a retention time range of the specific component; a waveform processor configured to execute waveform processing on the synthesized chromatogram created by the chromatogram synthesizer and obtain waveform processing information for defining a region of a peak of the specific component of the synthesized chromatogram; and a chromatogram processor configured to define a region of a peak of the specific component of each of the plurality of analysis target chromatograms by applying the waveform processing information obtained by the waveform processor to each of the plurality of analysis target chromatograms.

In a first aspect of the above embodiment of the chromatogram analysis apparatus according to the present invention, the apparatus further includes a chromatogram adjustor configured to adjust at least some of the plurality of chromatograms in a retention time direction so that appearance positions of peaks of the same component among the plurality of chromatograms coincide with each other, and the analysis target chromatogram holder is configured to hold the plurality of chromatograms adjusted by the chromatogram adjustor as the plurality of analysis target chromatograms. Even if analysis is executed under the same analysis conditions for a plurality of samples, the appearance positions of peaks of the same component may differ; however, according to this first aspect, since adjustment can be made so that the appearance positions of peaks of the same component coincide, the chromatograms of those samples can be synthesized as analysis target chromatograms and collective waveform processing can be performed.

Further, in a second aspect of the above embodiment of the chromatogram analysis apparatus according to the present invention, the chromatogram synthesizer is configured to create the synthesized chromatogram by summing signals of the plurality of analysis target chromatograms. This second aspect can be combined with the first aspect described above.

Further, in a third aspect of the above embodiment of the chromatogram analysis apparatus according to the present invention, the predetermined range is a range arbitrarily set by a user. According to such an aspect, since the user can synthesize a plurality of analysis target chromatograms in a retention time range that the user wants to analyze and execute collective waveform processing, waveform processing of unnecessary retention time ranges can be omitted, and the time required for analysis can be reduced. This third aspect can be combined with the first aspect and/or the second aspect described above.

In an embodiment of the chromatogram analysis method according to the present invention, the method includes: a preparation step of preparing a plurality of analysis target chromatograms obtained by analyzing a plurality of samples containing a specific component at different concentrations under the same analysis conditions; a synthesis step of creating a synthesized chromatogram by synthesizing the plurality of analysis target chromatograms prepared in the preparation step with each other in a predetermined range including at least a retention time range of the specific component; a waveform processing step of executing waveform processing on the synthesized chromatogram created in the synthesis step and obtaining waveform processing information for defining a region of a peak of the specific component of the synthesized chromatogram; a chromatogram processing step of defining a region of a peak of the specific component of each of the plurality of analysis target chromatograms by applying the waveform processing information obtained in the waveform processing step to each of the plurality of analysis target chromatograms; and a chromatogram evaluation step of evaluating the plurality of analysis target chromatograms based on the region of the peak of the specific component of each of the plurality of analysis target chromatograms defined in the chromatogram processing step.

In a first aspect of the above embodiment of the chromatogram analysis method according to the present invention, the preparation step includes a chromatogram adjustment step of adjusting at least some of the plurality of chromatograms in a retention time direction to cause appearance positions of peaks of the same component among the plurality of chromatograms to coincide with each other. Even if analysis is executed under the same analysis conditions for a plurality of samples, the appearance positions of peaks of the same component may differ; however, according to this first aspect, since adjustment can be made so that the appearance positions of peaks of the same component coincide, the chromatograms of those samples can be synthesized as analysis target chromatograms and collective waveform processing can be performed. This first aspect can be combined with the second aspect described below.

Further, in a second aspect of the above embodiment of the chromatogram analysis method according to the present invention, in the synthesis step, the synthesized chromatogram is created by summing signals of the plurality of analysis target chromatograms.

Further, in a third aspect of the above embodiment of the chromatogram analysis method according to the present invention, the synthesis step includes a step of setting the predetermined range. According to such an aspect, since the user can synthesize a plurality of analysis target chromatograms in a retention time range that the user wants to analyze and execute collective waveform processing, waveform processing of unnecessary retention time ranges can be omitted, and the time required for analysis can be reduced. This third aspect can be combined with the first aspect and/or the second aspect described above.

### Reference Signs List

1 Chromatogram analysis apparatus
2 Chromatogram adjustor
4 Analysis target chromatogram holder
6 Chromatogram synthesizer
8 Waveform processor
10 Chromatogram processor
100 Analysis device
200 Display device

1. A chromatogram analysis apparatus comprising:
an analysis target chromatogram holder that holds a plurality of analysis target chromatograms obtained by analyzing a plurality of samples containing a specific component at different concentrations under the same analysis conditions;
a chromatogram synthesizer configured to create a synthesized chromatogram by synthesizing the plurality of analysis target chromatograms held by the analysis target chromatogram holder with each other in a predetermined range including at least a retention time range of the specific component;
a waveform processor configured to execute waveform processing on the synthesized chromatogram created by the chromatogram synthesizer and obtain waveform processing information for defining a region of a peak of the specific component of the synthesized chromatogram; and
a chromatogram processor configured to define a region of a peak of the specific component of each of the plurality of analysis target chromatograms by applying the waveform processing information obtained by the waveform processor to each of the plurality of analysis target chromatograms.

2. The chromatogram analysis apparatus according to claim 1, further comprising a chromatogram adjustor configured to adjust at least some of a plurality of chromatograms in a retention time direction so that appearance positions of peaks of the same component among the plurality of chromatograms coincide with each other, wherein the analysis target chromatogram holder is configured to hold the plurality of chromatograms adjusted by the chromatogram adjustor as the plurality of analysis target chromatograms.

3. The chromatogram analysis apparatus according to claim 1, wherein the chromatogram synthesizer is configured to create the synthesized chromatogram by summing signals of the plurality of analysis target chromatograms.

4. The chromatogram analysis apparatus according to claim 1, wherein the predetermined range is a range arbitrarily set by a user.

5. A chromatogram analysis method comprising:
a preparation step of preparing a plurality of analysis target chromatograms obtained by analyzing a plurality of samples containing a specific component at different concentrations under the same analysis conditions;
a synthesis step of creating a synthesized chromatogram by synthesizing the plurality of analysis target chromatograms prepared in the preparation step with each other in a predetermined range including at least a retention time range of the specific component;
a waveform processing step of executing waveform processing on the synthesized chromatogram created in the synthesis step and obtaining waveform processing information for defining a region of a peak of the specific component of the synthesized chromatogram;
a chromatogram processing step of defining a region of a peak of the specific component of each of the plurality of analysis target chromatograms by applying the waveform processing information obtained in the waveform processing step to each of the plurality of analysis target chromatograms; and
a chromatogram evaluation step of evaluating the plurality of analysis target chromatograms based on the region of the peak of the specific component of each of the plurality of analysis target chromatograms defined in the chromatogram processing step.

6. The chromatogram analysis method according to claim 5, wherein the preparation step includes a chromatogram adjustment step of adjusting at least some of a plurality of chromatograms in a retention time direction to cause appearance positions of peaks of the same component among the plurality of chromatograms to coincide with each other.

7. The chromatogram analysis method according to claim 5, wherein in the synthesis step, the synthesized chromatogram is created by summing signals of the plurality of analysis target chromatograms.

8. The chromatogram analysis method according to claim 5, wherein the synthesis step includes a step of setting the predetermined range.
